(19) United States
(12) Patent Application Publication
(10) Pub. No.: US 2024/0020360 A1
(43) Pub. Date: Jan. 18, 2024

(54) COMPUTER SYSTEM, SOFTWARE TAMPERING VERIFICATION METHOD, AND NON-TRANSITORY COMPUTER READABLE MEDIUM

(71) Applicant: NEC Platforms, Ltd., Kawasaki-Shi, Kanagawa (JP)

(72) Inventor: Tatsuo OWADA, Kanagawa (JP)

(73) Assignee: NEC Platforms, Ltd., Kawasaki-Shi, Kanagawa (JP)

(21) Appl. No.: 18/036,622

(22) PCT Filed: Sep. 6, 2021
(86) PCT No.: PCT/JP2021/032686

§ 371 Date: May 11, 2023

(30) Foreign Application Priority Data
Nov. 19, 2020 (JP) 2020-192257

(51) Int. Cl. G06F 21/12

(52) U.S. Cl. CPC G06F 21/12

(57) ABSTRACT

The monitor unit starts an aggregating processing program in a normal world, inputs verification input data to an aggregating processing unit, and obtains normal output data. The monitor unit compares the secure output data with the normal output data. When the secure output data and the normal output data match each other, the monitor unit determines that the aggregating processing program has not been tampered with after the aggregating processing program is installed since the aggregating processing program and the aggregating processing program are identical. When the secure output data and the normal output data do not match each other, the monitor unit determines that the aggregating processing program has been tampered with after the aggregating processing program is installed since the aggregating processing program and the aggregating processing program are not identical.

### TECHNICAL FIELD

The present invention relates to a computer system, a software tampering verification method, and a program.

### BACKGROUND ART

As a security technology for various types of devices, TrustZone (Registered Trademark), which is standardly mounted on a CPU of Cortex-A (Registered Trademark) series of ARM (Registered Trademark) Limited, is known.

In TrustZone, a “secure world” as an execution environment for executing a secure OS and a “normal world” as an execution environment for executing a non-secure OS are configured so that they are virtually separated from each other.

Software (referred to as a secure applet) that operates in the secure world can access all information in the normal world. Software that operates in the normal world, on the other hand, has limited access to information in the secure world, and can access the information in the secure world only through a secure monitor that operates in the secure world.

For example, by storing fingerprint data for a fingerprint sensor and encryption keys for DRM in the secure world, it is possible to reduce risks due to tampering with or leakage of the fingerprint data and the encryption keys.

Patent Literature 1 provides a technology for ensuring the security of software that operates in the normal world. Specifically, a development entity of software that operates in the normal world gives the software itself an authentication key. That is, the software that operates in the normal world includes an authentication key. The software that operates in the normal world presents the authentication key to software that operates in the secure world. The software that operates in the secure world verifies the authentication key, thereby determining that the software that operates in the normal world is legitimate and can be trusted.

### CITATION LIST

### Patent Literature

Patent Literature 1: Japanese Patent No. 5877400

### SUMMARY OF INVENTION

### Technical Problem

In the above Patent Literature 1, when software that operates in the normal world has been tampered with and an authentication key given to the software itself has not been tampered with, it is possible to detect that the software has been tampered with.

However, when both of the software that operates in the normal world and the authentication key given to the software itself have been tampered with, it is not possible to detect that the software has been tampered with.

An object of the present disclosure is to provide a technology for verifying whether or not software installed in a normal world has been tampered with.

### Solution to Problem

The present disclosure provides a computer system including:
a normal storage as a storage in a normal world, a first software being installed in the normal storage;
a secure storage as a storage in a secure world, a second software being installed in the secure storage, and input data being stored in the secure storage;
a secure side software execution unit configured to start, in the secure world, the second software installed in the secure storage, input the input data to the second software, and obtain secure output data as output data output from the second software;
a normal side software execution unit configured to start, in the normal world, the first software installed in the normal storage, input the input data to the first software, and obtain normal output data as output data output from the first software; and
a tampering determination unit configured to compare the secure output data with the normal output data, determine that, when the secure output data and the normal output data match each other, the first software has not been tampered with since the first software and the second software are identical, and determine that, when the secure output data and the normal output data do not match each other, the first software has been tampered with since the first software and the second software are not identical.

The present disclosure provides a computer system including:
a secure storage as a storage in a secure world, verification data being stored in the secure storage, the verification data including input data and output data, the output data being output, from software that has not been tampered with, when the input data is input to the software;
a normal storage as a storage in a normal world, the software being installed in the normal storage;
a software execution unit configured to start, in the normal world, normal software as the software installed in the normal storage, input the input data to the normal software, and obtain normal output data as output data output from the normal software; and
a tampering determination unit configured to compare the normal output data with the output data included in the verification data, determine that, when the normal output data and the output data included in the verification data match each other, the normal software has not been tampered with, and determine that, when the normal output data and the output data included in the verification data do not match each other, the normal software has been tampered with.

The present disclosure provides a software tampering verification method including:
a verification preparation step of installing software in a secure storage as a storage in a secure world and installing software identical to the software installed in the secure storage in a normal storage as a storage in a normal world, and storing input data in the secure storage;
a secure side software execution step of starting, in the secure world, secure software as the software installed in the secure storage, inputting the input data to the secure software, and obtaining secure output data as output data output from the secure software;
a normal side software execution step of starting, in the normal world, normal software as the software installed in the normal storage, inputting the input data to the normal software, and obtaining normal output data as output data output from the normal software; and
a tampering determination step of comparing the secure output data with the normal output data, determining that, when the secure output data and the normal output data match each other, the normal software has not been tampered with since the normal software and the secure software are identical, and determining that, when the secure output data and the normal output data do not match each other, the normal software has been tampered with since the normal software and the secure software are not identical.

The present disclosure provides a software tampering verification method including:
a verification preparation step of installing software in a normal storage as a storage in a normal world and storing, in a secure storage as a storage in a secure world, verification data including input data and output data, the output data being output, from the software that has not been tampered with, when the input data is input to the software;
a software execution step of starting, in the normal world, normal software as the software installed in the normal storage, inputting the input data to the normal software, and obtaining normal output data as output data output from the normal software; and
a tampering determination step of comparing the normal output data with the output data included in the verification data, determining that, when the normal output data and the output data included in the verification data match each other, the normal software has not been tampered with, and determining that, when the normal output data and the output data included in the verification data do not match each other, the normal software has been tampered with.

### Advantageous Effects of Invention

According to the present invention, it is possible to verify whether or not software installed in a normal world has been tampered with.

### BRIEF DESCRIPTION OF DRAWINGS

FIG. 1 is a functional block diagram of a computer system (first example embodiment);

FIG. 2 is a functional block diagram of a computer system (second example embodiment);

FIG. 3 shows a control flow of the computer system (second example embodiment);

FIG. 4 is a functional block diagram of a computer system (third example embodiment);

FIG. 5 is a functional block diagram of a computer system (fourth example embodiment);

FIG. 6 is a diagram showing contents stored in a verification data storage unit (fourth example embodiment); and

FIG. 7 shows a control flow of a computer system (fourth example embodiment).

### EXAMPLE EMBODIMENT

### First Example Embodiment

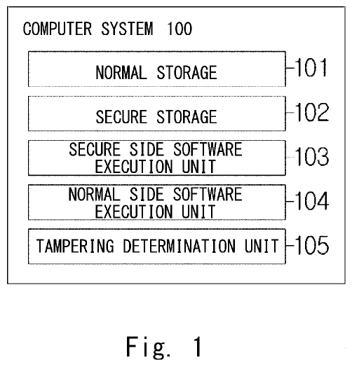

A first example embodiment of the present invention will be described 30 below with reference to FIG. 1.

As shown in FIG. 1, a computer system 100 includes a normal storage 101 and a secure storage 102. The computer system 100 includes a secure side software execution unit 103 and a normal side software execution unit 104. The computer system 100 further includes a tampering determination unit 105.

The normal storage 101 is a normal storage as a storage in a normal world. A first software is installed in the normal storage 101.

The secure storage 102 is a secure storage as a storage in a secure world. A second software is installed in the secure storage 102. The secure storage 102 stores input data.

The first software and the second software are identical software at least at the time they are installed.

The secure side software execution unit 103 starts, in the secure world, the second software installed in the secure storage. The secure side software execution unit 103 inputs input data to the second software. The secure side software execution unit 103 obtains secure output data as output data output from the second software.

The normal side software execution unit 104 starts, in the normal world, the first software installed in the normal storage. The normal side software execution unit 104 inputs input data to the first software. The normal side software execution unit 104 obtains normal output data as output data output from the first software.

The tampering determination unit 105 compares the secure output data with the normal output data. When the secure output data and the normal output data match each other, the tampering determination unit 105 determines that the first software has not been tampered with since the first software and the second software are identical. When the secure output data and the normal output data do not match each other, the tampering determination unit 105 determines that the first software has been tampered with since the first software and the second software are not identical.

According to the above configuration, even when software masquerades as a legitimate program by attaching, to the software, a certificate that has been tampered with, it is possible to verify whether or not the software has been tampered with after the point in time when the software is installed in the normal storage 101.

### Second Example Embodiment

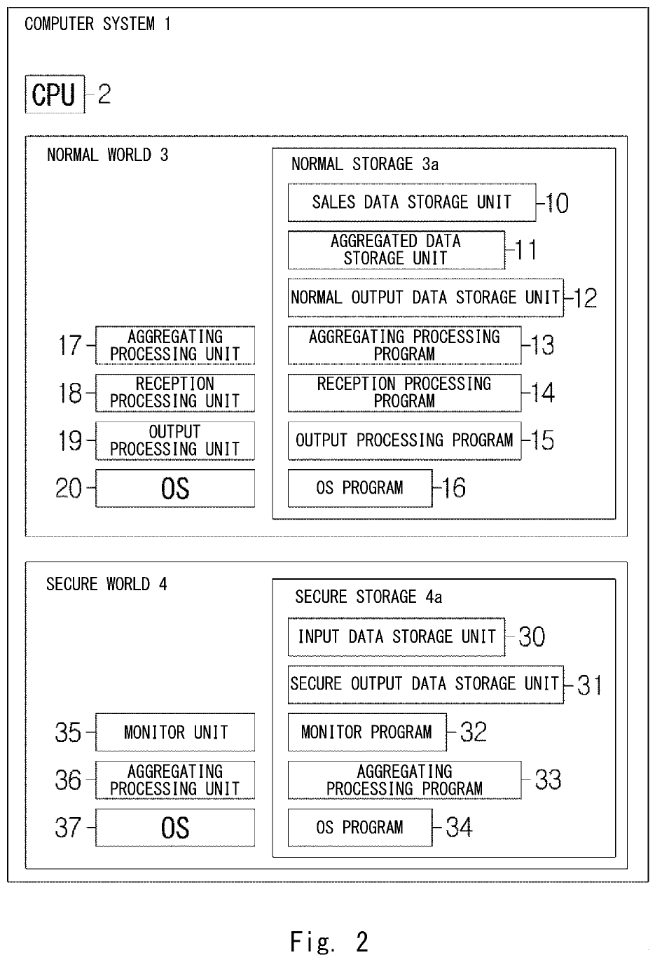

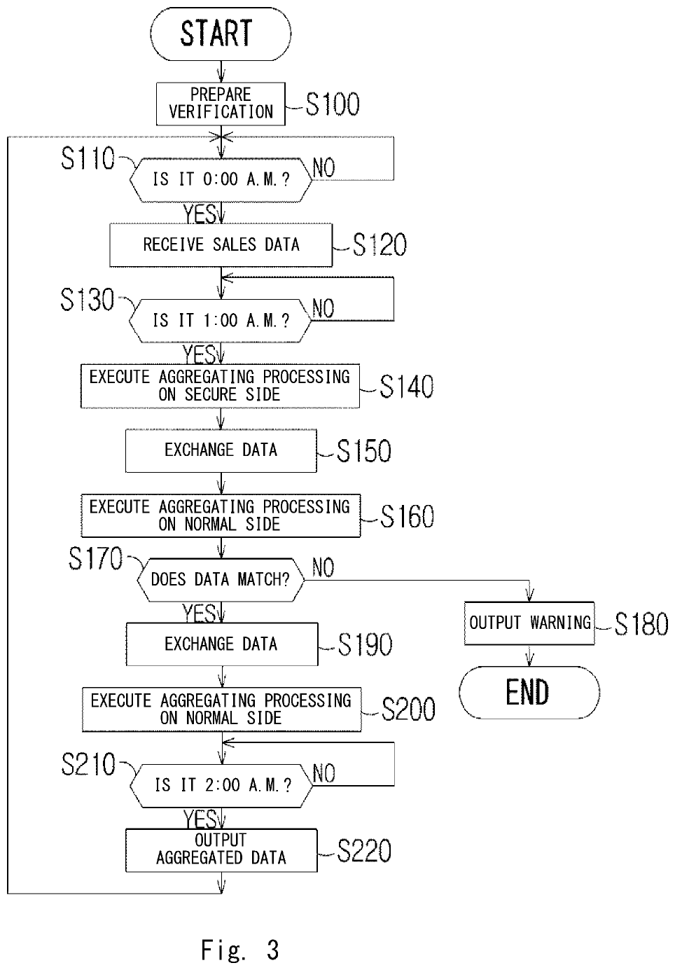

A second example embodiment of the present invention will be described below with reference to FIGS. 2 and 3.

FIG. 2 shows a computer system 1 that is configured so that a normal world 3 and a secure world 4 are virtually separated from each other. The computer system 1 typically includes a CPU 2 of Cortex-A (Registered Trademark) series of ARM (Registered Trademark) Limited. In the computer system 1, the normal world 3 and the secure world 4 are configured so that they are virtually separated from each other by TrustZone (Registered Trademark) standardly mounted on the CPU 2.

Software that operates in the secure world 4 can access all information in the normal world 3 and the secure world 4. In contrast, although software that operates in the normal world 3 can access all the information in the normal world 3, it has limited access to the information in the secure world 4. The software that operates in the normal world 3 can access the information in the secure world 4 only through a secure monitor that operates in the secure world 4.

As shown in FIG. 2, the normal world 3 includes a normal storage 3a. The secure world 4 includes a secure storage 4a. Each of the normal storage 3a and the secure storage 4a is composed of a storage apparatus such as a HDD.

The normal storage 3a includes a sales data storage unit 10, an aggregated data storage unit 11, and a normal output data storage unit 12. An aggregating processing program 13, a reception processing program 14, an output processing program 15, and an OS program 16 are installed in the normal storage 3a.

The CPU 2 loads the aggregating processing program 13, the reception processing program 14, the output processing program 15, and the OS program 16, and executes the loaded programs in the normal world 3. By doing so, the aggregating processing program 13 causes a hardware resource in the normal world 3 to function as an aggregating processing unit 17. The reception processing program 14 causes a hardware resource in the normal world 3 to function as a reception processing unit 18. The output processing program 15 causes a hardware resource in the normal world 3 to function as an output processing unit 19. The OS program 16 causes a hardware resource in the normal world 3 to function as a normal OS 20 (a non-secure OS). The aggregating processing unit 17, the reception processing unit 18, and the output processing unit 19 are executed on the normal OS 20.

The secure storage 4a includes an input data storage unit 30 and a secure output data storage unit 31. A monitor program 32, an aggregating processing program 33, and an OS program 34 are installed in the secure storage 4a.

The CPU 2 loads the monitor program 32, the aggregating processing program 33, and the OS program 34, and executes the loaded programs in the secure world 4. By doing so, the monitor program 32 causes a hardware resource in the secure world 4 to function as a monitor unit 35. The aggregating processing program 33 causes a hardware resource in the secure world 4 to function as an aggregating processing unit 36. The OS program 34 causes a hardware resource in the secure world 4 to function as a secure OS 37. The monitor unit 35 and the aggregating processing unit 36 are executed on the secure OS 37.

Note that the order in which the CPU 2 starts various types of programs is typically as follows. That is, first, the CPU 2 starts a boot loader stored in a mask ROM (not shown), and next the CPU 2 starts various types of programs after the boot loader is started. Specifically, the CPU 2 starts the secure OS 37 and then starts the monitor unit 35 and the aggregating processing unit 36. Next, the CPU 2 starts the normal OS 20 and then starts the aggregating processing unit 17, the reception processing unit 18, and the output processing unit 19. When various types of programs are started, the CPU 2 starts various types of programs while verifying the certificates attached to the various types of programs.

The normal OS 20 operating system is the same as the secure OS 37 operating system. Both the normal OS 20 and the secure OS 37 are typically Windows (Registered Trademark) or Linux (Registered Trademark). As a result, it is possible to run software on the normal OS 20 that is identical to that run on the secure OS 37.

The aggregating processing unit 17 aggregates sales data stored in the sales data storage unit 10, and stores the aggregated data, which aggregated data is a result of the aggregating processing, in the aggregated data storage unit 11. The aggregating processing unit 17 typically stores sales data and aggregated data in the aggregated data storage unit 11. The sales data is a specific example of data to be processed. The aggregating processing unit 17 is a specific example of a data processing unit. The aggregating processing unit 17 is a specific example of software. The aggregating processing unit 17 is a specific example of normal software.

The reception processing unit 18 receives sales data from an external apparatus and stores the received sales data in the sales data storage unit 10. For example, the reception processing unit 18 receives sales data from apparatuses respectively installed in branch stores through a public communication line.

The output processing unit 19 outputs sales data and aggregated data stored in the aggregated data storage unit 11 to a display (not shown). However, alternatively, the output processing unit 19 may transmit sales data and aggregated data stored in the aggregated data storage unit 11 to an external apparatus through a public communication line.

The monitor unit 35 accesses the normal storage 3a in the normal world 3 and the secure storage 4a in the secure world 4 without limitation, starts various types of programs in the normal world 3 and the secure world 4, and controls the various types of programs started.

The aggregating processing unit 36 aggregates verification input data (i.e., input data for verification) stored in the input data storage unit 30 and stores secure output data, which secure output data is a result of the aggregating processing, in the secure output data storage unit 31. The aggregating processing unit 36 is a specific example of software. The aggregating processing unit 36 is a specific example of secure software. The input data is data for verification and is equivalent to daily sales data of all branch stores.

Note that the aggregating processing program 33 is installed in the secure storage 4a in the secure world 4, and hence there is no possibility that it will be tampered with. On the other hand, the aggregating processing program 13 is installed in the normal storage 3a in the normal world 3, and hence there is possibility that it will be tampered with. Verification of whether or not the aggregating processing program 13 installed in the normal storage 3a in the normal world 3 has been tampered with after the aggregating processing program 13 is installed will be described in detail below.

FIG. 3 shows a control flow of the computer system 1.

### S100: (Verification Preparation Step)

First, the aggregating processing program 13 is installed in the normal storage 3a and the aggregating processing program 33 is installed in the secure storage 4a. The aggregating processing program 13 and the aggregating processing program 33 are identical software at least at the time they are installed. Further, verification input data is stored in the input data storage unit 30 of the secure storage 4a. The verification input data is a specific example of input data.

After the above step, steps S110 to S220 are performed periodically. In this example embodiment, the steps S110 to S220 are performed daily. That is, the steps S110 to S220 are performed once a day at a predetermined time.

### S110:

Next, the monitor unit 35 determines whether the current time is 0:00 a.m. When a result of the determination is YES, the monitor unit 35 advances the process to S120. When a result of the determination is NO, the monitor unit 35 repeats the process of S110.

### S120:

Next, the monitor unit 35 instructs the reception processing unit 18 to receive data. By doing so, the reception processing unit 18 receives daily sales data of branch stores from apparatuses respectively set in the branch stores, and stores the received sales data in the sales data storage unit 10.

### S130:

Next, the monitor unit 35 determines whether the current time is 1:00 a.m. When a result of the determination is YES, the monitor unit 35 advances the process to S140. When a result of the determination is NO, the monitor unit 35 repeats the process of S130.

### S140: (Secure Side Software Execution Step)

Next, the monitor unit 35 starts in the secure world 4 the aggregating processing program 33 installed in the secure storage 4a, inputs the verification input data to the aggregating processing unit 36, and obtains secure output data as output data output from the aggregating processing unit 36. The monitor unit 35 stores the secure output data in the secure output data storage unit 31.

### S150:

Next, the monitor unit 35 stores the verification input data in the sales data storage unit 10. At this time, it is necessary to avoid the sales data stored in the sales data storage unit 10 from being overwritten and lost. Therefore, when the monitor unit 35 stores the verification input data in the sales data storage unit 10, the monitor unit 35 temporarily saves the sales data stored in the sales data storage unit 10. For example, the monitor unit 35 stores the verification input data in the sales data storage unit 10 and stores the sales data in the input data storage unit 30. That is, the monitor unit 35 exchanges contents stored in the sales data storage unit with contents stored in the input data storage unit 30. However, alternatively, the monitor unit 35 may temporarily save the sales data stored in the sales data storage unit 10 in a storage unit of the normal storage 3a other than the sales data storage unit 10.

### S160: (Normal Side Software Execution Step)

Next, the monitor unit 35 starts in the normal world 3 the aggregating processing program 13 installed in the normal storage 3a, inputs the verification input data to the aggregating processing unit 17, and obtains normal output data as output data output from the aggregating processing unit 17. The monitor unit 35 stores the normal output data in the normal output data storage unit 12.

### S170: (Tampering Determination Step)

Next, the monitor unit 35 compares the secure output data stored in the secure output data storage unit 31 with the normal output data stored in the normal output data storage unit 12. When a result of the comparison is NO, the monitor unit 35 determines that the aggregating processing unit 17 (the aggregating processing program 13) has been tampered with after the aggregating processing program 13 is installed since the aggregating processing unit 17 and the aggregating processing unit 36 are not identical, and then advances the process to S180. When a result of the comparison is YES, the monitor unit 35 determines that the aggregating processing unit 17 (the aggregating processing program 13) has not been tampered with after the aggregating processing program 13 is installed since the aggregating processing unit 17 and the aggregating processing unit 36 are identical, and then advances the process to S190.

### S180:

The monitor unit 35 generates a message for warning that the aggregating processing unit 17 (the aggregating processing program 13) has been tampered with. The output processing unit 19 displays the message on a display (not shown) and ends the process.

### S190:

The monitor unit 35 exchanges contents stored in the sales data storage unit with contents stored in the input data storage unit 30. By doing so, the sales data received by the reception processing unit 18 in S120 is stored again in the sales data storage unit 10.

### S200:

Next, the monitor unit 35 inputs the sales data to the aggregating processing unit 17, and stores in the aggregated data storage unit 11 the aggregated data and the sales data as output data output from the aggregating processing unit 17.

### S210:

Next, the monitor unit 35 determines whether the current time is 2:00 a.m. When a result of the determination is YES, the monitor unit 35 advances the process to S220. When a result of the determination is NO, the monitor unit 35 repeats the process of S210.

### S220:

Then the output processing unit 19 outputs the aggregated data stored in the aggregated data storage unit 11 and the sales data of the previous day to a display (not shown).

The second example embodiment has been described above, and the above-described second example embodiment has the following features.

That is, as shown in FIG. 2, the computer system 1 is a computer system configured so that the secure world 4 is virtually separated from the normal world 3. The computer system 1 detects tampering of the aggregating processing program 13 (software) installed in the normal world 3. Specifically, the computer system 1 includes the normal storage 3a, the secure storage 4a, and the monitor unit 35. The normal storage 3a is a storage in the normal world 3. The aggregating processing program 13 (the first software) is installed in the normal storage 3a. The secure storage 4a is a storage in the secure world 4. The aggregating processing program 33 (the second software) is installed in the secure storage 4a. The input data storage unit 30 of the secure storage 4a stores verification input data (input data). The monitor unit 35 functions as the secure side software execution unit, the normal side software execution unit, and the tampering determination unit. The monitor unit 35 starts in the secure world 4 the aggregating processing program 33 installed in the secure storage 4a, inputs the verification input data to the aggregating processing unit 36, and obtains secure output data as output data output from the aggregating processing unit 36. The monitor unit 35 starts in the normal world 3 the aggregating processing program 13 installed in the normal storage 3a, inputs the verification input data to the aggregating processing unit 17, and obtains normal output data as output data output from the aggregating processing unit 17. The monitor unit 35 then compares the secure output data with the normal output data. When the secure output data and the normal output data match each other, the monitor unit 35 determines that the aggregating processing program 13 has not been tampered with after the aggregating processing program 13 is installed since the aggregating processing program 13 and the aggregating processing program 33 are identical. When the secure output data and the normal output data do not match each other, the monitor unit 35 determines that the aggregating processing program 13 has been tampered with after the aggregating processing program 13 is installed since the aggregating processing program 13 and the aggregating processing program 33 are not identical. According to the above configuration, even when the aggregating processing program 13 masquerades as a legitimate program by attaching, to the aggregating processing program 13, a certificate that has been tampered with, it is possible to verify whether or not the aggregating processing program 13 has been tampered with after the point in time when the aggregating processing program 13 is installed in the normal storage 3a.

Further, as shown in FIG. 3, a software tampering verification method using the computer system 1 includes the verification preparation step (S100), the secure side software execution step (S140), the normal side software execution step (S160), and the tampering determination step (S170). In the verification preparation step (S100), software is installed in the secure storage 4a, software identical to the software installed in secure storage 4a is installed in the normal storage 3a, and verification input data is stored in the secure storage 4a. In the secure side software execution step (S140), the aggregating processing program 33 installed in the secure storage 4a is started in the secure world 4, the verification input data is input to the aggregating processing unit 36, and secure output data as output data output from the aggregating processing unit 36 is obtained. In the normal side software execution step (S160), the monitor unit 35 starts in the normal world 3 the aggregating processing program 13 installed in the normal storage 3a, inputs the verification input data to the aggregating processing unit 17, and obtains normal output data as output data output from the aggregating processing unit 17. Then, in the tampering determination step (S170), the monitor unit 35 compares the secure output data with the normal output data. When the secure output data and the normal output data match each other, the monitor unit 35 determines that the aggregating processing program 13 has not been tampered with after the aggregating processing program 13 is installed since the aggregating processing program 13 and the aggregating processing program 33 are identical. When the secure output data and the normal output data do not match each other, the monitor unit 35 determines that the aggregating processing program 13 has been tampered with after the aggregating processing program 13 is installed since the aggregating processing program 13 and the aggregating processing program 33 are not identical. According to the above method, even when the aggregating processing program 13 masquerades as a legitimate program by attaching, to the aggregating processing program 13, a certificate that has been tampered with, it is possible to verify whether or not the aggregating processing program 13 has been tampered with after the point in time when the aggregating processing program 13 is installed in the normal storage 3a.

### Third Example Embodiment

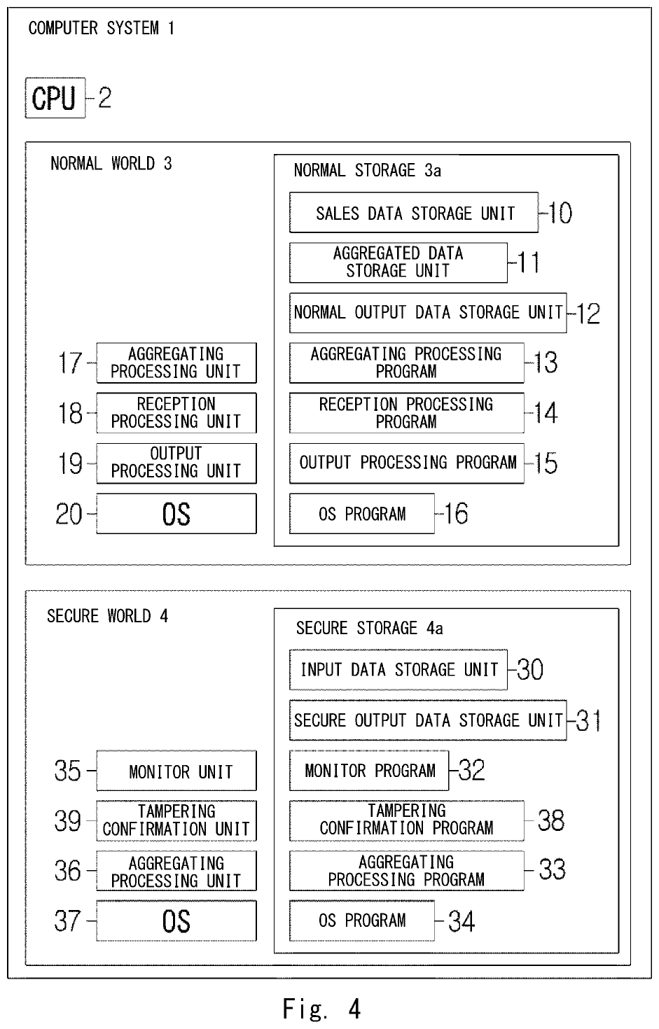

A third example embodiment of the present invention will be described below with reference to FIG. 4. This third example embodiment will be described below with a focus on differences between it and the second example embodiment described above, and descriptions of this example embodiment which are the same as those of the second example embodiment will be omitted.

As shown in FIG. 4, in this example embodiment, a tampering confirmation program 38 is installed in the secure storage 4a in the secure world 4. The CPU 2 loads the tampering confirmation program 38 and executes it in the secure world 4. By doing so, the tampering confirmation program 38 causes a hardware resource in the secure world 4 to function as a tampering confirmation unit 39. The tampering confirmation unit 39 is executed on the secure OS 37.

The tampering confirmation unit 39 has some of the functions of the monitor unit 35 according to the second example embodiment. That is, the tampering confirmation unit 39 executes the processes of S110 to S220 shown in FIG. 3 through the monitor unit 35.

### Fourth Example Embodiment

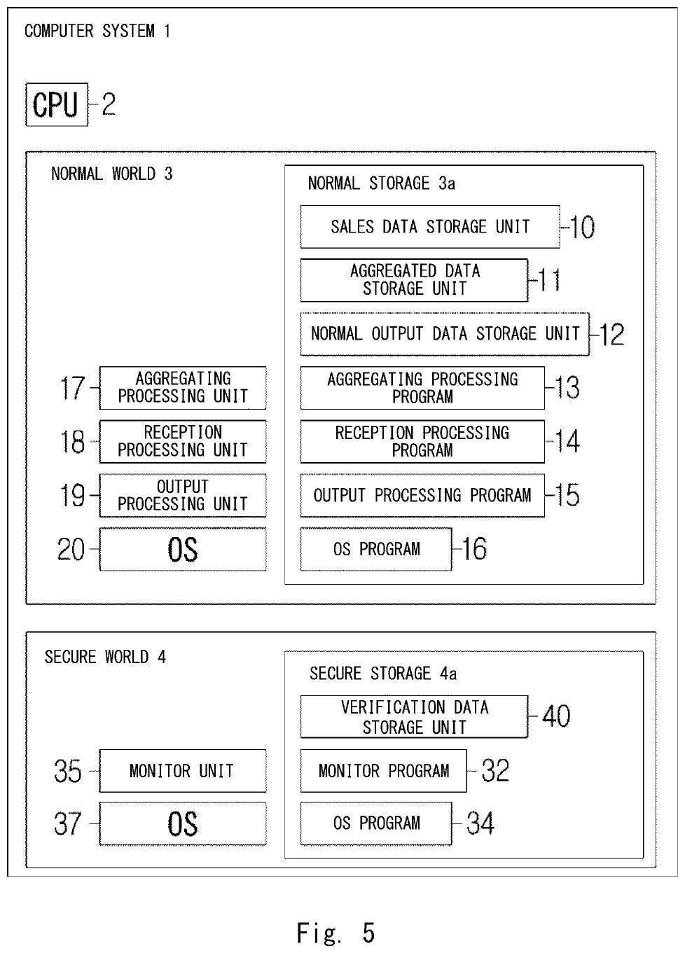

A fourth example embodiment of the present invention will be described below with reference to FIGS. 5 to 7. This fourth example embodiment will be described below with a focus on differences between it and the second example embodiment described above, and descriptions of this example embodiment which are the same as those of the second example embodiment will be omitted.

In the second example embodiment described above, as shown in FIG. 2, the secure storage 4a includes the input data storage unit 30 and the secure output data storage unit 31. Further, the aggregating processing program 33 is installed in the secure storage 4a.

In contrast, in this example embodiment, as shown in FIG. 5, the secure storage 4a does not include the input data storage unit 30 and the secure output data storage unit 31. The secure storage 4a includes a verification data storage unit 40 instead of these storage units. The aggregating processing program 33 is not installed in the secure storage 4a.

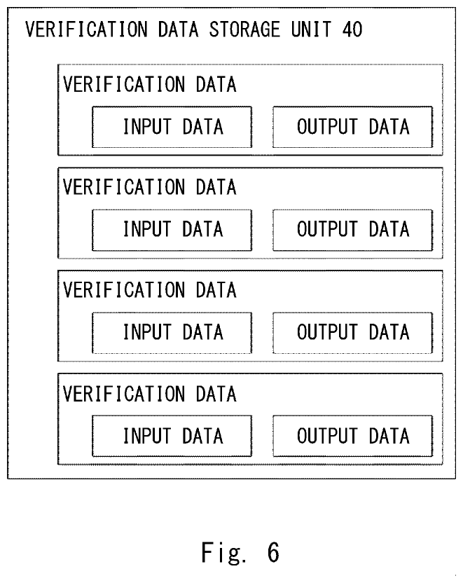

FIG. 6 shows the contents stored in the verification data storage unit 40. As shown in FIG. 6, the verification data storage unit 40 stores a plurality of pieces of verification data. Each of the pieces of verification data includes input data, and output data (ground truth data) that is output, from the aggregating processing unit 17 that has not been tampered with, when the input data is input to the aggregating processing unit 17.

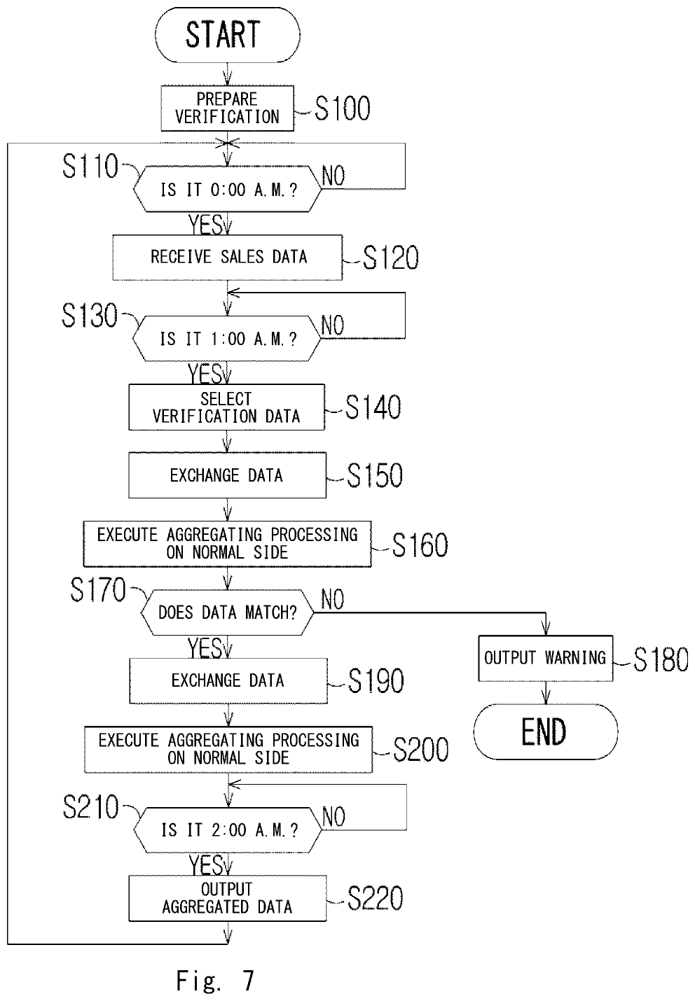

FIG. 7 shows a control flow of the computer system 1.

### S100: (Verification Preparation Step)

First, the aggregating processing program 13 is installed in the normal storage 3a. Further, a plurality of pieces of verification data are stored in the verification data storage unit 40 of the secure storage 4a.

### S140: (Software Execution Step)

The monitor unit 35 selects one of the plurality of pieces of verification data stored in the verification data storage unit 40. At this time, the monitor unit selects the piece of verification data different from the piece of verification data previously used from among the plurality of pieces of verification data. The monitor unit 35 may randomly select one of the plurality of pieces of verification data. In this way, the reliability of verification is improved by selecting verification data that differs for each verification or by using randomly selected verification data.

### S150:

Next, the monitor unit 35 stores input data included in the selected verification data in the sales data storage unit 10. At this time, it is necessary to avoid the sales data stored in the sales data storage unit 10 from being overwritten and lost. Therefore, when the monitor unit 35 stores the input data included in the verification data in the sales data storage unit 10, the monitor unit 35 temporarily saves the sales data stored in the sales data storage unit 10. For example, the monitor unit 35 stores the input data included in the verification data in the sales data storage unit 10 and stores the sales data in the verification data storage unit 40. That is, the monitor unit 35 exchanges contents stored in the sales data storage unit 10 with contents stored in the verification data storage unit 40. However, alternatively, the monitor unit 35 may temporarily save the sales data stored in the sales data storage unit 10 in a storage unit of the normal storage 3a other than the sales data storage unit 10.

### S160: (Normal Side Software Execution Step)

Next, the monitor unit 35 starts in the normal world 3 the aggregating processing program 13 installed in the normal storage 3a, inputs the input data included in the verification data to the aggregating processing unit 17, and obtains normal output data as output data output from the aggregating processing unit 17. The monitor unit 35 stores the normal output data in the normal output data storage unit 12.

### S170: (Tampering Determination Step)

Next, the monitor unit 35 compares the output data included in the verification data selected in S140 with the normal output data stored in the normal output data storage unit 12. When a result of the comparison is NO, the monitor unit 35 determines that the aggregating processing unit 17 (the aggregating processing program 13) has been tampered with after the aggregating processing program 13 is installed, and then advances the process to S180. When a result of the comparison is YES, the monitor unit 35 determines that the aggregating processing unit 17 (the aggregating processing program 13) has not been tampered with after the aggregating processing program 13 is installed, and then advances the process to S190.

### S190:

The monitor unit 35 exchanges contents stored in the sales data storage unit with contents stored in the verification data storage unit 40. By doing so, the sales data received by the reception processing unit 18 in S120 is stored again in the sales data storage unit 10.

The fourth example embodiment has been described above, and the above-described fourth example embodiment has the following features. That is, as shown in FIG. 5, the computer system 1 is a computer system configured so that the secure world 4 is virtually separated from the normal world 3. The computer system 1 detects tampering of the aggregating processing program 13 (software) installed in the normal world 3. Specifically, the computer system 1 includes the normal storage 3a, the secure storage 4a, and the monitor unit 35. The normal storage 3a is a storage in the normal world 3. The aggregating processing program 13 is installed in the normal storage 3a. The secure storage 4a is a storage in the secure world 4. The secure storage 4a stores the verification data. The monitor unit 35 functions as the software execution unit and the tampering determination unit. The monitor unit 35 starts in the normal world 3 the aggregating processing program 13 installed in the normal storage 3a, inputs the input data included in the verification data to the aggregating processing unit 17, and obtains normal output data as output data output from the aggregating processing unit 17. The monitor unit 35 compares the normal output data with the output data included in the verification data. When the normal output data and the output data of the verification data match each other, the monitor unit 35 determines that the aggregating processing program 13 has not been tampered with after the aggregating processing program 13 is installed. When the normal output data and the output data of the verification data do not match each other, the monitor unit 35 determines that the aggregating processing program 13 has been tampered with after the aggregating processing program 13 is installed. According to the above configuration, even when the aggregating processing program 13 masquerades as a legitimate program by attaching, to the aggregating processing program 13, a certificate that has been tampered with, it is possible to verify whether or not the aggregating processing program 13 has been tampered with after the point in time when the aggregating processing program 13 is installed in the normal storage 3a.

Further, as shown in FIG. 6, the secure storage 4a stores a plurality of pieces of verification data. The monitor unit 35 uses the verification data different from the verification data previously used. Alternatively, the monitor unit 35 randomly selects one of the plurality of pieces of verification data and uses the selected piece of verification data. In this way, the reliability of verification is improved by selecting verification data that differs for each verification or by using randomly selected verification data. However, only one piece of verification data may be stored in the secure storage 4a.

Further, as shown in FIG. 7, a software tampering verification method using the computer system 1 includes the verification preparation step (S100), the software execution step (S160), and the tampering determination step (S170). In the verification preparation step (S100), the aggregating processing program 13 is installed in the normal storage 3a and verification data is stored in the secure storage 4a. In the software execution step (S160), the monitor unit 35 starts in the normal world 3 the aggregating processing program 13, inputs the input data included in the verification data to the aggregating processing unit 17, and obtains normal output data as output data output from the aggregating processing unit 17. Then, in the tampering determination step (S170), the monitor unit 35 compares the normal output data with the output data included in the verification data. When the normal output data and the output data of the verification data match each other, the monitor unit 35 determines that the aggregating processing program 13 has not been tampered with after the aggregating processing program 13 is installed. When the normal output data and the output data of the verification data do not match each other, the monitor unit 35 determines that the aggregating processing program 13 has been tampered with after the aggregating processing program 13 is installed. According to the above method, even when the aggregating processing program 13 masquerades as a legitimate program by attaching, to the aggregating processing program 13, a certificate that has been tampered with, it is possible to verify whether or not the aggregating processing program 13 has been tampered with after the point in time when the aggregating processing program 13 is installed in the normal storage 3a.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present invention is not limited to the above-described example embodiments and may be changed as appropriate without departing from the scope and spirit of the present invention.

In the above-described example embodiments 1 to 4, whether or not the aggregating processing program 13 has been tampered is verified. However, a program to be verified is not limited to the aggregating processing program 13, and may be programs other than the aggregating processing program 13, such as an image processing program and a traffic prediction program.

This application is based upon and claims the benefit of priority from Japanese patent application No. 2020-192257, filed on Nov. 19, 2020, the disclosure of which is incorporated herein in its entirety by reference.

### REFERENCE SIGNS LIST

1 COMPUTER SYSTEM
2 CPU
3 NORMAL WORLD
3a NORMAL STORAGE
4 SECURE WORLD
4a SECURE STORAGE
10 SALES DATA STORAGE UNIT
11 AGGREGATED DATA STORAGE UNIT
12 NORMAL OUTPUT DATA STORAGE UNIT
13 AGGREGATING PROCESSING PROGRAM
14 RECEPTION PROCESSING PROGRAM
15 OUTPUT PROCESSING PROGRAM
16 OS PROGRAM
17 AGGREGATING PROCESSING UNIT
18 RECEPTION PROCESSING UNIT
19 OUTPUT PROCESSING UNIT
20 NORMAL OS
30 INPUT DATA STORAGE UNIT
31 SECURE OUTPUT DATA STORAGE UNIT
32 MONITOR PROGRAM
33 AGGREGATING PROCESSING PROGRAM
34 OS PROGRAM
35 MONITOR UNIT
36 AGGREGATING PROCESSING UNIT
37 SECURE OS
38 TAMPERING CONFIRMATION PROGRAM
39 TAMPERING CONFIRMATION UNIT
40 VERIFICATION DATA STORAGE UNIT

What is claimed is:

1. A computer system comprising:
a normal storage as a storage in a normal world, a first software being installed in the normal storage;
a secure storage as a storage in a secure world, a second software being installed in the secure storage, and input data being stored in the secure storage;
a secure side software execution unit configured to start, in the secure world, the second software installed in the secure storage, input the input data to the second software, and obtain secure output data as output data output from the second software;
a normal side software execution unit configured to start, in the normal world, the first software installed in the normal storage, input the input data to the first software, and obtain normal output data as output data output from the first software; and
a tampering determination unit configured to compare the secure output data with the normal output data, determine that, when the secure output data and the normal output data match each other, the first software has not been tampered with since the first software and the second software are identical, and determine that, when the secure output data and the normal output data do not match each other, the first software has been tampered with since the first software and the second software are not identical.

2. A computer system comprising:
a secure storage as a storage in a secure world, verification data being stored in the secure storage, the verification data including input data and output data, the output data being output, from software that has not been tampered with, when the input data is input to the software;
a normal storage as a storage in a normal world, the software being installed in the normal storage;
a software execution unit configured to start, in the normal world, normal software as the software installed in the normal storage, input the input data to the normal software, and obtain normal output data as output data output from the normal software; and
a tampering determination unit configured to compare the normal output data with the output data included in the verification data, determine that, when the normal output data and the output data included in the verification data match each other, the normal software has not been tampered with, and determine that, when the normal output data and the output data included in the verification data do not match each other, the normal software has been tampered with.

3. The computer system according to claim 2, wherein
the secure storage stores a plurality of pieces of the verification data, and
the software execution unit and the tampering determination unit use the piece of the verification data different from the piece of the verification data previously used.

4. The computer system according to claim 2, wherein
the secure storage stores a plurality of pieces of the verification data, and
the software execution unit and the tampering determination unit randomly select one of the plurality of pieces of the verification data and use the selected piece of the verification data.

5. A software tampering verification method comprising:
a verification preparation step of installing software in a secure storage as a storage in a secure world and installing software identical to the software installed in the secure storage in a normal storage as a storage in a normal world, and storing input data in the secure storage;
a secure side software execution step of starting, in the secure world, secure software as the software installed in the secure storage, inputting the input data to the secure software, and obtaining secure output data as output data output from the secure software;
a normal side software execution step of starting, in the normal world, normal software as the software installed in the normal storage, inputting the input data to the normal software, and obtaining normal output data as output data output from the normal software; and
a tampering determination step of comparing the secure output data with the normal output data, determining that, when the secure output data and the normal output data match each other, the normal software has not been tampered with since the normal software and the secure software are identical, and determining that, when the secure output data and the normal output data do not match each other, the normal software has been tampered with since the normal software and the secure software are not identical.

6. A software tampering verification method comprising:
a verification preparation step of installing software in a normal storage as a storage in a normal world and storing, in a secure storage as a storage in a secure world, verification data including input data and output data, the output data being output, from the software that has not been tampered with, when the input data is input to the software;
a software execution step of starting, in the normal world, normal software as the software installed in the normal storage, inputting the input data to the normal software, and obtaining normal output data as output data output from the normal software; and
a tampering determination step of comparing the normal output data with the output data included in the verification data, determining that, when the normal output data and the output data included in the verification data match each other, the normal software has not been tampered with, and determining that, when the normal output data and the output data included in the verification data do not match each other, the normal software has been tampered with.

7. The software tampering verification method according to claim 6, wherein
in the verification preparation step, a plurality of pieces of the verification data are stored in the secure storage, and
in the software execution step and the tampering determination step, the piece of the verification data different from the piece of the verification data previously used is used.

8. The software tampering verification method according to claim 6, wherein
in the verification preparation step, a plurality of pieces of the verification data are stored in the secure storage, and
in the software execution step and the tampering determination step, one of the plurality of pieces of the verification data is randomly selected and the selected piece of the verification data is used.

9. A non-transitory computer readable medium storing a program for causing a computer to execute the software tampering verification method according to claim 5.

10. A non-transitory computer readable medium storing a program for causing a computer to execute the software tampering verification method according to claim 6.
